(19) United States
(12) Patent Application Publication
(10) Pub. No.: US 2015/0078472 A1
(43) Pub. Date: Mar. 19, 2015

(54) Feedback Methodology for Per-User Elevation MIMO

(71) Applicant: Nokia Solutions and Networks Oy, Espoo (FI)

(72) Inventors: Frederick Vook, Schaumburg, IL (US); Bishwarup Mondal, Beavercreek, OH (US); Timothy Thomas, Palatine (IL); Eugene Visotsky, Buffalo Grove (IL)

(21) Appl. No.: 14/389,551

(22) PCT Filed: Apr. 2, 2013
(86) PCT No.: PCT/EP2013/056874

§ 371 Date: Sep. 30, 2014

Related U.S. Application Data
(60) Provisional application No. 61/617,901, filed on Mar. 30, 2012.

(51) Int. Cl. H04B 7/04

(52) U.S. Cl. CPC H04B 7/0417; H04B 7/0456
USPC 375/267

(57) ABSTRACT

A method includes receiving downlink reference signals from a transmit antenna array having of rows of azimuth antenna elements and columns of elevation antenna elements; computing first channel state information feedback components assuming azimuth-only adaptation; computing second channel state information feedback components assuming elevation-only adaptation; computing third channel state information feedback components assuming elevation-adaptation and elevation adaptation; and feeding back the first, second and third channel state information feedback components.

### TECHNICAL FIELD

The exemplary and non-limiting embodiments of this invention relate generally to wireless communication systems, methods, devices and computer programs and, more specifically, relate to multiple input multiple output (MIMO), closed loop MIMO, downlink (DL) single user MIMO (SU-MIMO), antenna array processing, beamforming, elevation beamforming, antenna array deployment in cellular systems, codebook feedback, 3D MIMO and precoder matrix index (PMI) feedback.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section. Abbreviations that may be found in the specification and/or the drawing figures are defined below, prior to the claims.

Typical antenna deployments include an array of horizontally arranged antenna elements that are processed for adaptivity in the azimuth dimension. Recent architectures have been proposed for creating arrays that effectively contain antenna elements arranged both vertically and horizontally, which therefore promise the ability to adapt in both azimuth and elevation dimensions. However, there problems with implementation of the systems with the ability to adapt in both azimuth and elevation dimensions.

### BRIEF SUMMARY

This is intended to be introductory and contains examples of possible implementations.

In accordance with a first aspect thereof the exemplary embodiments of this invention provide a method that comprises receiving downlink reference signals from a transmit antenna array comprised of rows of azimuth antenna elements and columns of elevation antenna elements; computing first channel state information feedback components assuming azimuth-only adaptation; computing second channel state information feedback components assuming elevation-only adaptation; computing third channel state information feedback components assuming elevation-adaptation and elevation adaptation; and feeding back the first, second and third channel state information feedback components.

In accordance with another exemplary embodiment, a computer program is disclosed that includes program code for executing the method according to the previous paragraph. Another exemplary embodiment is the computer program according to the previous paragraph, wherein the computer program is a computer program product comprising a computer-readable medium bearing computer program code embodied therein for use with a computer.

In accordance with a further aspect thereof the exemplary embodiments of this invention provide an apparatus that operates in accordance with the foregoing method. For instance, an apparatus includes a processor and a memory including computer program code. The memory and computer program code are configured to, with the processor, cause the apparatus at least to perform the following: receive downlink reference signals from a transmit antenna array comprised of rows of azimuth antenna elements and columns of elevation antenna elements; compute first channel state information feedback components assuming azimuth-only adaptation; compute second channel state information feedback components assuming elevation-only adaptation; compute third channel state information feedback components assuming azimuth-adaptation and elevation adaptation; and feed back the first, second and third channel state information feedback components.

As another example, an apparatus comprises: means for receiving downlink reference signals from a transmit antenna array comprised of rows of azimuth antenna elements and columns of elevation antenna elements; means for computing first channel state information feedback components assuming azimuth-only adaptation; means for computing second channel state information feedback components assuming elevation-only adaptation; means for computing third channel state information feedback components assuming azimuth-adaptation and elevation adaptation; and means for feeding back the first, second and third channel state information feedback components.

### BRIEF DESCRIPTION OF THE DRAWINGS

FIG. 1 provides an overview of conventional antenna panel designs.

FIGS. 2 and 3 are useful when explaining two methods to achieve an elevational beamforming architecture and implementation, where FIG. 2 shows a first method and FIG. 3 shows a second method.

FIG. 4 shows an antenna array architecture for supporting 3D-MIMO, where in this non-limiting example there are M=4 antennas in azimuth and E=3 antennas in elevation.

FIGS. 5 and 6 illustrate controlling the antenna array for 3D-MIMO, where FIG. 5 depicts a Rank 1 transmission (M=4, E=3) and FIG. 6 depicts a Rank 2 transmission (M=4, E=2).

FIG. 7 is a graph that shows a result of a simulation and depicts a fixed antenna down-tilt versus a variable down-tilt that is made possible by the use of this invention, and depicts the gain in throughput that is made possible.

FIG. 8 illustrates an overall simplified block diagram of a system that includes a plurality of UEs and an eNB, the system being configured so as to operate in accordance with the embodiments of this invention.

FIGS. 9 and 10 are each a logic flow diagram that illustrates the operation of a method, and a result of execution of computer program instructions, in accordance with the exemplary embodiments of this invention.

### DETAILED DESCRIPTION

A problem that arises, and that is addressed and solved by this invention, is the need for a feedback framework that efficiently enables the joint adaptation over both azimuth and elevation for closed-loop SU-MIMO and MU-MIMO.

While the description herein is provided primarily in the context of FDD systems, the embodiments of this invention are not limited for use with only FDD systems.

Prior proposals and existing implementations do not address or do not adequately address the feedback methodology that would be required for controlling both azimuth and elevation in closed-loop SU/MU-MIMO.

Some conventional proposals would adapt the elevation pattern on a per-sector basis, not on a per-user (a per-UE) basis and, therefore, do not provide a feedback methodology suitable to enable an adaptive per-user joint elevation/azimuth capability.

Extending the existing azimuth-only MIMO methods to support closed-loop adaptation in both the azimuth and elevation dimensions can provide significant gains in system performance, especially on the cell edge. The embodiments of this invention provide a flexible and efficient framework for supporting closed-loop adaptation in both azimuth and elevation for downlink MIMO transmission. Feedback messaging in support of this closed-loop adaptation in both azimuth and elevation to support joint adaptation in azimuth and elevation in FDD systems is provided, where uplink/downlink channel reciprocity cannot be directly exploited

The embodiments of this invention provide a feedback methodology for enabling joint elevation and azimuth beamforming/closed-loop MIMO transmission. In the exemplary embodiments a task of computing transmit weights is decomposed into two separable processes, one for azimuth and one for elevation. Three types of feedback messages are created: azimuth-oriented feedback (e.g., azimuth PMI), elevation-oriented feedback (e.g., elevation PMI), and feedback messages that account for joint elevation and azimuth adaptivity (e.g., CQI and rank determination). A schedule is created for all three types of feedback, where some feedback can be UE-triggered rather than pre-arranged or requested by the eNB.

One non-limiting advantage of per-user azimuth/elevation optimization is that it provides more tailored control of the elevation pattern to further optimize the link to the UE. The approach of separating the azimuth-oriented feedback from the elevation-oriented feedback provides efficiencies in that the elevation-oriented feedback typically may not change as rapidly as the azimuth-oriented feedback.

Before describing in greater detail several non-limiting embodiments in accordance with this invention it may prove useful to discuss in greater detail some of the background technology associated with the invention.

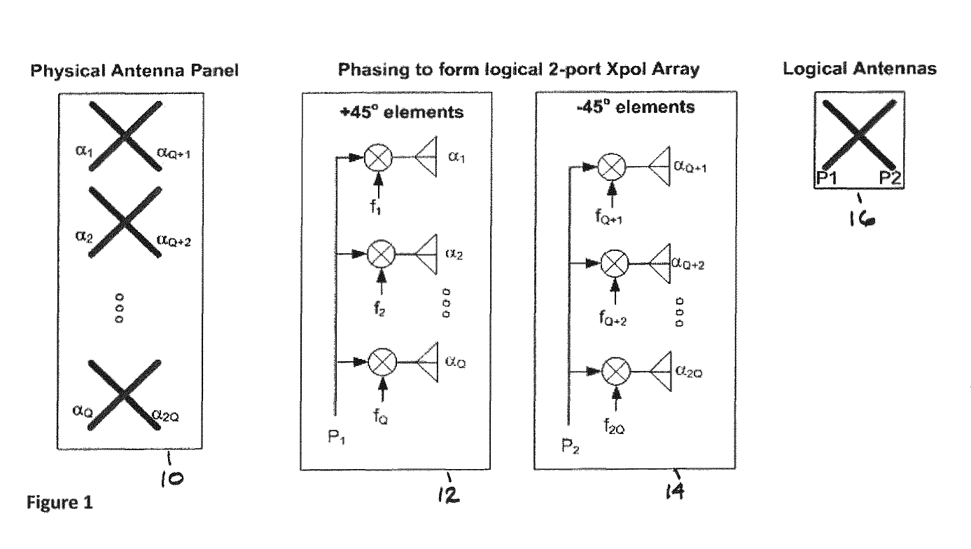

FIG. 1 provides an overview of conventional antenna panel designs. A physical XPOL Antenna Panel 10 is typically comprised of multiple +45° antenna sub-elements and multiple −45° antenna sub-elements. The +45° sub-elements are phased to form a logical +45° antenna 12 and the −45° sub-elements are phased to form a logical −45° antenna 14. The result is two logical antennas 16, one with +45° and the other with −45° polarization. A similar concept applies to a panel array containing co-pol (co-polarization) vertical elements (not shown). The phasing used in antennas 12 and 14 is intended to create a specific antenna pattern in the elevation dimension. The use of a mechanical downtilt can also be used to optimize cell coverage. The elevation pattern is typically very narrow in macrocells in order to increase the overall antenna gain and to cover the cell from a high tower.

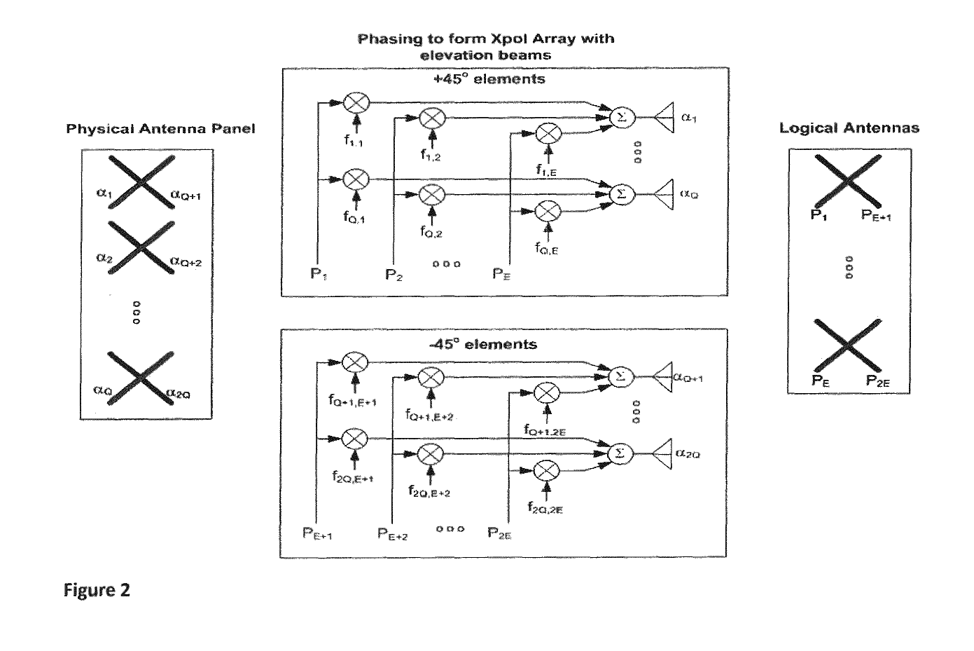

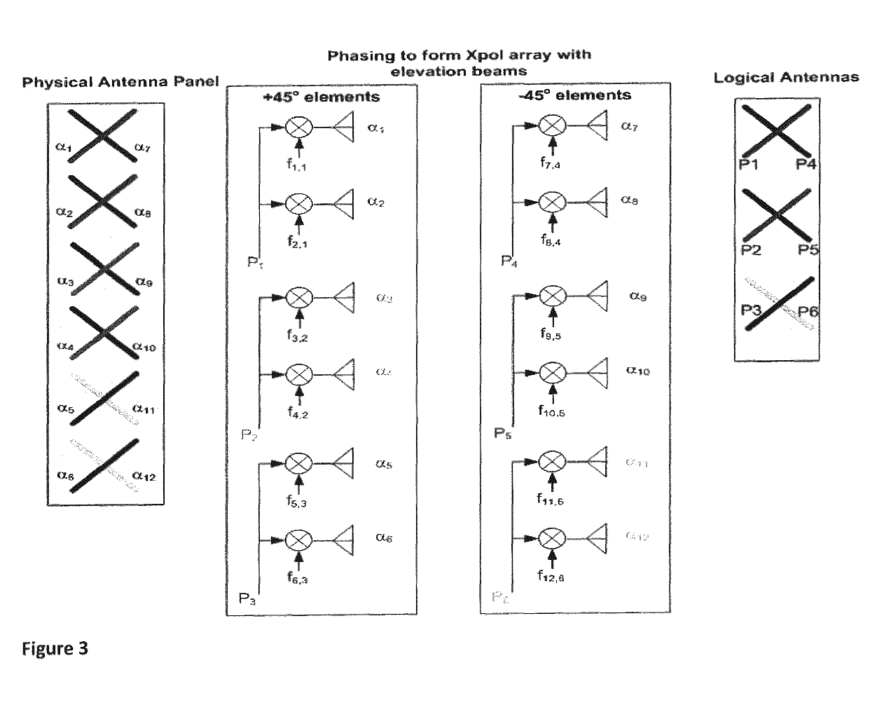

FIGS. 2 and 3 are useful when explaining two methods to achieve an elevational beamforming architecture and implementation. In general, this involves creating multiple-beams per polarization via phasing of the co-pol sub-elements. In the first method (FIG. 2) each elevation beam for a given polarization is formed using all of the sub-elements of that polarization. In the second method (FIG. 3) each elevation beam for a given polarization uses a non-overlapping subset of the sub-elements. Each panel contains some number of vertical elements for each of the two polarizations. The array at the eNB can then have multiple panels to provide elements in azimuth.

In the first method (FIG. 2) there are 2Q total sub-elements in the panel with Q elements per polarization in the panel. The effect is to form E beams from the Q elements for each polarization, and the result is that the panel forms a logical E×2 vertical array of cross pols. Tx weights are applied to the inputs to the logical cross pols (i.e., ports P₁ . . . P_{2E}) to beamform in the elevation dimension. The Tx weights that form the logical cross pol antennas (i.e., the weights f₁₁ . . . f_{QE}) are typically applied at the RF level (i.e., after upmixing), whereas the Tx weights that are applied to the input to the logical cross pol ports (not shown in the figure) are typically applied at baseband.

In the second method (FIG. 3), and assuming an example of Q=6 elements per polarization in the panel, for each polarization E=3 beams are formed, each from two of the sub-elements with that polarization. The result is a 3×2 Xpol logical array in the vertical dimension. Tx weights are applied to the inputs of the beams (i.e., ports P₁ . . . P₆) for elevation beamforming. One advantage over the first method of FIG. 2 is that fewer components are required (note that no summer elements (Σ) are needed in the antenna).

FIGS. 1-3 have described techniques to create an antenna panel array that logically consists of E vertical elements for each of two polarizations, i.e., for the XPOL case: +/−45, V/H and for the Co-Pol case: VV, HH.

It can be noted that other techniques can also be used to create an antenna architecture capable of supporting vertical beamforming. For example, a simple method is simply to arrange a set of physical cross pol elements in a two-dimensional layout that consist of M elements in azimuth and E elements in elevation. The feedback methods in accordance with non-limiting embodiments of this invention can be applied to any array architecture having a two-dimensional layout.

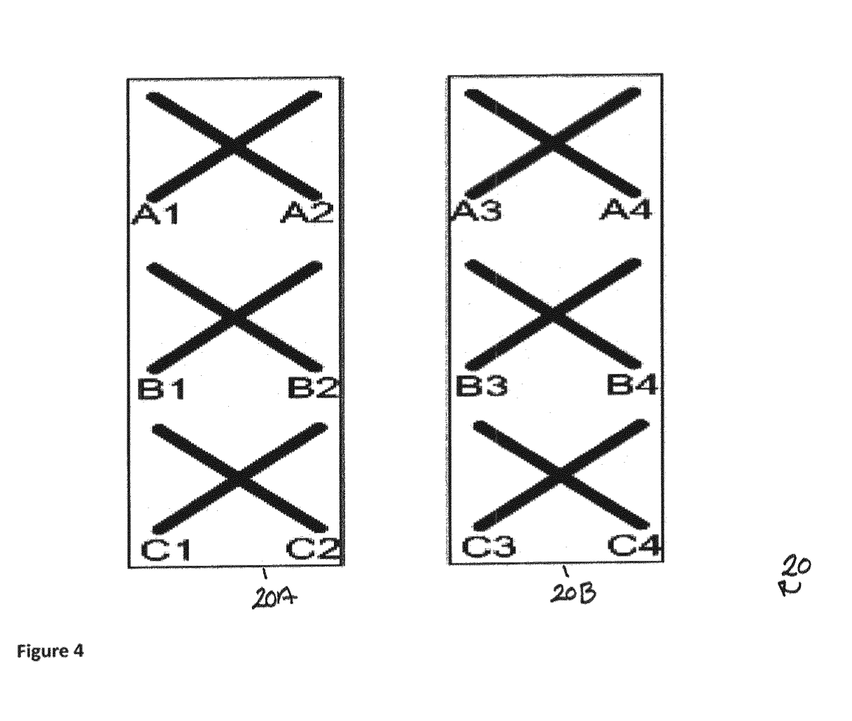

As can be seen in FIG. 4 an antenna array 20 at the eNB can include multiple panels (e.g., two panels 20A, 20B) to provide azimuth elements. The overall array size can be similar to existing structures. An example of an overall logical array structure, as shown in FIG. 4, can contain two cross-pol panels with each panel containing E=3 logical cross pol arrays in the vertical dimension and six transceivers per column.

The configuration in FIG. 4 assumes an antenna configuration containing a two-dimensional layout of cross-polarized antennas. In this example there are M=4 antennas in the azimuth dimension and E=3 antennas in the vertical (elevation) dimension. The antennas are labeled according to an alphanumeric scheme in which the letter (A, B, C . . . ) refers to the “row” in which the antenna is located and the number refers to the azimuth location of the antenna. Odd numbers refer to an element with +45° polarization while even numbers refer to elements with −45° polarization.

With the two-dimensional array structure of FIG. 4 any of the existing methodologies for closed-loop transmission can be applied. For example, codebook feedback-based methodologies can be applied to this array structure by establishing an M×E-antenna codebook where the UE selects the best precoder matrix and feeds back the index of the best precoder matrix (precoder matrix index, or PMI) to the base station. If the product of M and E is equal to 2, 4, or 8, then the codebooks that are already defined in 3GPP can be used in a straightforward manner. However, since the codebooks currently defined in 3GPP were designed for azimuth-only adaptation with a linear one-dimensional array structure, the straightforward use of those codebooks with a two-dimensional array structure will not provide the best performance. Furthermore, it might be desirable to deploy arrays where M×E is not equal to 2, 4, or 8, in which case an M×E-antenna codebook would have to be designed. Moreover, if the product of M×E becomes very large, for example greater than 8, then the codebook search complexity may become unacceptable compared to legacy 3GPP codebooks. Also, with large values of M×E, the pilot overhead necessary for allowing the UE to measure the channel to all M×E antennas may become unacceptable as well. As a result, there is a need for a better solution than simply designing an M×E codebook for the two dimensional array structure at the base station.

Current antenna arrays are sector-specific with respect to vertical beamforming, with the vertical beamforming implementation being based on, for example, the second method shown in FIG. 3. The entire signal bandwidth (all traffic and control) is transmitted using the same vertical phasing weights and uses cell-specific adaptation based on traffic/UE conditions/distribution in the cell.

A problem that this presents, and which the embodiments of this invention alleviate, is how to provide user-specific (UE-specific) vertical beamforming/MIMO. The embodiments of this invention address the problem of how to control the vertical beamforming in conjunction with the azimuth-based closed-loop transmission methods that are already supported in the LTE standard.

In accordance with the embodiments of this invention there is provided an architecture that provides for and enables elevation beamforming. Considering the exemplary antenna array as shown in FIG. 4, there may be M azimuth elements by E vertical beams, a total of E×2 transceivers per column and M×E total transceivers. In the non-limiting example of FIG. 4, and as was noted above, M=4, E=3, and M×E=12.

The overall problem to be addressed relates to extending the “traditional” azimuth-oriented transmit antenna array techniques that are currently enabled in the standards to handle the elevation dimension on a user-specific (UE-specific) basis.

A more specific problem that is addressed by the embodiments of this invention is the design of a feedback framework (feedback from the UE) for enabling joint adaptation over both elevation and azimuth in closed-loop SU-MIMO and MU-MIMO.

The embodiments will be primarily described in reference to FDD systems rather than TDD systems for at least the reason that TDD systems can leverage TDD reciprocity as opposed to relying on a UE feedback message. However, it should be kept in mind that the embodiments of this invention are applicable to both FDD and TDD systems.

As was also noted above, currently existing precoder codebook methodologies are designed and used under the assumption of a one-dimensional array configuration (e.g., linear array of vertical or cross-pol elements), and there is no accounting for two dimensions (i.e., elevation and azimuth). Further, the currently existing feedback methodologies such as covariance feedback (analog/digital), eigenvector feedback (analog/digital), etc. employ CRS/CSI-RS plus feedback messages where there is an assumption of a one-dimensional array configuration. The currently defined UE feedback messages assume the linear one dimensional array configuration (where there is no accounting for antenna elements arranged both vertically and horizontally).

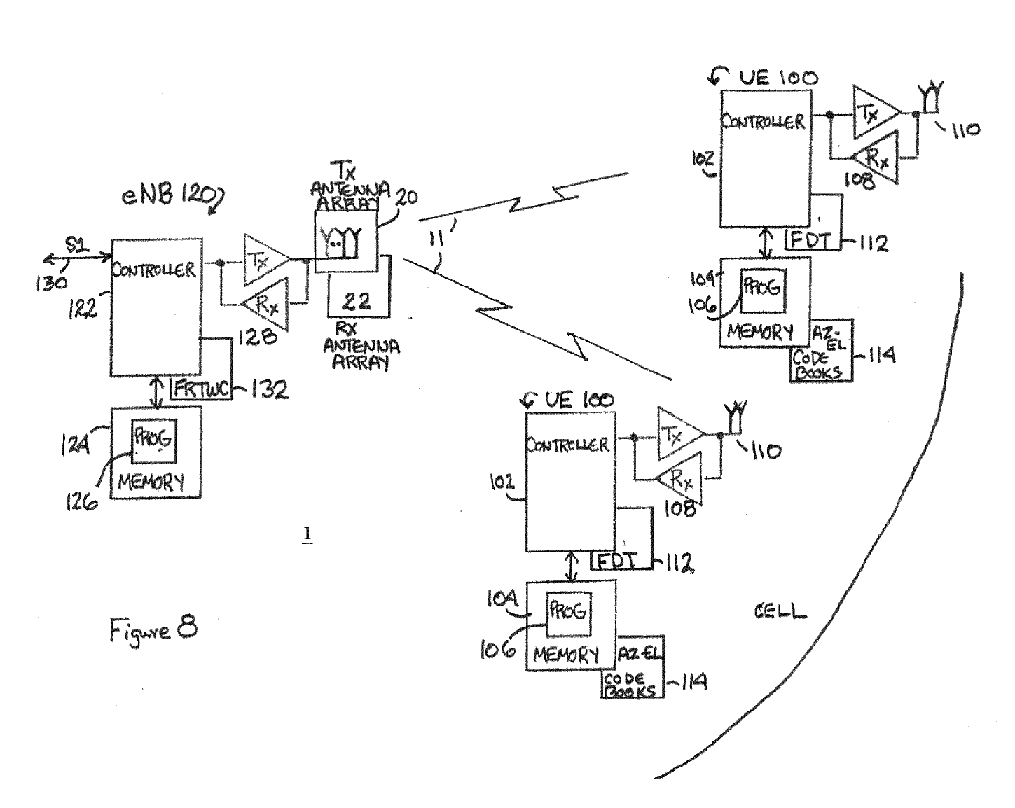

Before further describing the invention, reference can be made to FIG. 8 for showing one example of a wireless communication system 1 that can benefit from the use of this invention. The system 1 can be an LTE system such as one that may be compatible with a Release 12 (Rel-12) of LTE. Note that higher releases of LTE (higher than Rel-12) can also benefit from the use of this invention, as can other types of wireless communication systems.

The system 1 includes a plurality of apparatus which may be referred to without a loss of generality as client devices or nodes or stations or UEs 100. The system 1 further includes another apparatus which may be referred to without a loss of generality as a base station or a network access node or an access point or a NodeB or an eNB 120 that communicates via wireless radio frequency (RF) links 11 with the UEs 100. While two UEs 100 are shown in practice there could tens or hundreds of UEs 100 that are served by a cell or cells established by the eNB 120. Each UE 100 includes a controller 102, such as at least one computer or a data processor, at least one non-transitory computer-readable memory medium embodied as a memory 104 that stores a program of computer instructions (PROG) 106, and at least one suitable RF transmitter (Tx) and receiver (Rx) pair (transceiver) 108 for bidirectional wireless communications with the eNB 120 via antennas 110.

The eNB 120 also includes a controller 122, such as at least one computer or a data processor, at least one computer-readable memory medium embodied as a memory 124 that stores a program of computer instructions (PROG) 126, and suitable RF transceivers 128 for communication with the UEs 100 via antenna arrays. A transmit antenna array 20 can be configured as shown in FIG. 4 and described above to include, as a non-limiting example, M azimuth elements by E vertical beams, a total of E×2 transceivers per column and M×E total transceivers (e.g., M=4, E=3, and M×E=12). Also provided is a receive antenna array 22.

The eNB 120 may be assumed to be interfaced with a core network (not shown) via an interface such as an S1 interface 130 that provides connectivity, in the LTE system, to a mobility management entity (MME) and a serving gateway (S-GW).

For the purposes of describing the exemplary embodiments of this invention the UEs 100 may be assumed to also include a feedback derivation and transmission (FDT) function 112 that operates in accordance with this invention, as described in detail below. The FDT function 112 operates in conjunction with azimuth and elevation codebooks 114. The eNB 120 may be assumed to also include a feedback reception, transmit weight calculation (FRTWC) function 132 that operates in accordance with this invention, as described in detail below.

At least one of the programs 106 and 126 is assumed to include program instructions that, when executed by the associated controller, enable the device to operate in accordance with the exemplary embodiments of this invention, as will be discussed below in greater detail. That is, the exemplary embodiments of this invention may be implemented at least in part by computer software executable by the controller 102 of the UEs 100 and/or by the controller 122 of the eNB 120, or by hardware, or by a combination of software and hardware (and firmware). The functionality of the FDTs 112 may also be implemented at least in part by computer software executable by the controller 102 of the UEs 100, or by hardware, or by a combination of software and hardware (and firmware). The functionality of the FRTWC 132 may also be implemented at least in part by computer software executable by the controller 122 of the eNB 120, or by hardware, or by a combination of software and hardware (and firmware).

The various controllers/data processors, memories, programs, transceivers and antenna arrays depicted in FIG. 8 may all be considered to represent means for performing operations and functions that implement the several non-limiting aspects and embodiments of this invention.

In general the various embodiments of the UEs 100 may include, but are not limited to, mobile communication devices, desktop computers, portable computers, image capture devices such as digital cameras, gaming devices, music storage and playback appliances, Internet appliances permitting wireless Internet access and browsing, and portable units or terminals that incorporate combinations of such functions.

The computer-readable memories 104 and 124 may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The controllers 102 and 122 may be of any type suitable to the local technical environment, and may include one or more of general purpose computers, special purpose computers, microprocessors, digital signal processors (DSPs) and processors based on multi-core processor architectures, as non-limiting examples.

The exemplary embodiments of this invention provide a transmission methodology for the eNB 120 where the transmit weight calculation (FRTWC 132) and the supporting feedback (FDT 112) methodologies are decomposed into two separable processes: one for azimuth and one for elevation. The eNB 120 is enabled to form multiple horizontal beams that are adapted in azimuth but arranged vertically. These multiple beams are co-phased together to adapt the elevation dimension.

The FDT 112 is used to establish azimuth-oriented feedback messages (e.g., codebook PMI/covariance matrix/eigenvectors, etc.) that enable adaptation in azimuth by the FRTWC 132. The FDT 112 is also used to establish elevation-oriented feedback messages (e.g., codebook PMI/covariance matrix/eigenvectors, etc.) that enable adaptation in elevation by the FRTWC 132. The FDT 112 is also used to establish joint feedback messages (e.g., rank indication (RI), CQI) that account for the adaptation that will occur in both elevation and azimuth. The FDT 112 is operated with the recognition that the adaptation rate for the feedback quantities contained in each of these three types of feedback messages may be different.

There are numerous non-limiting examples that fall into this general framework. For example, a precoder codebook is designed in such a way that the UE 100 knows which part of the precoder codebook is directed towards elevation and which part is directed towards azimuth. In accordance with this example a first PMI is fed back from the UE 100 to enable the eNB 120 to establish multiple azimuth beams that are arranged vertically. Then a second PMI is fed back to coherently co-phase the multiple azimuth beams to control the elevation dimension.

As another example, there may be covariance matrix feedback (analog or digital) that adapts one or both dimensions at a time. In accordance with this example, a first covariance matrix is fed back from the UE 100 to enable the eNB 120 to establish multiple azimuth beams that are arranged vertically. Then a second covariance matrix is fed back to enable the eNB 120 to calculate the transmit weights that will weight the multiple azimuth beams to control the elevation dimension. The covariance matrix that the UE 100 feeds back can be encoded according to a digital encoding technique, where the entries of the covariance matrix are for example quantized according to some number of bits and then transmitted as a binary message (e.g., techniques similar in concept to the technique used in the adaptive codebooks used in the IEEE802.16m standard). Alternatively, the covariance matrix can be encoded according to an analog encoding technique where for example the values of the entries of the covariance matrix modulate a subcarrier in an unquantized fashion.

As another example, there may be eigenvector feedback (analog or digital) that adapts one or both dimensions at a time. In this example, the UE 100 will first estimate the downlink covariance matrix from the reference signals transmitted by the eNB 120. Then, the UE 100 will compute one or more of the eigenvectors of the covariance matrix and encode the one or more eigenvectors into a feedback message and transmit that feedback message back to the eNB 120. As with the covariance matrix feedback example, the eigenvector feedback can be analog (i.e., unquantized) or digital (e.g., quantized and encoded into a digital message). The eNB 120 then uses the eigenvectors fed back from the UE 100 to adapt the azimuth dimension and/or the elevation dimension.

As another example, there may be one of PMI feedback, or covariance matrix feedback, or eigenvector feedback that adapts one dimension, and one of PMI feedback, or covariance matrix feedback, or eigenvector feedback that adapts the other dimension.

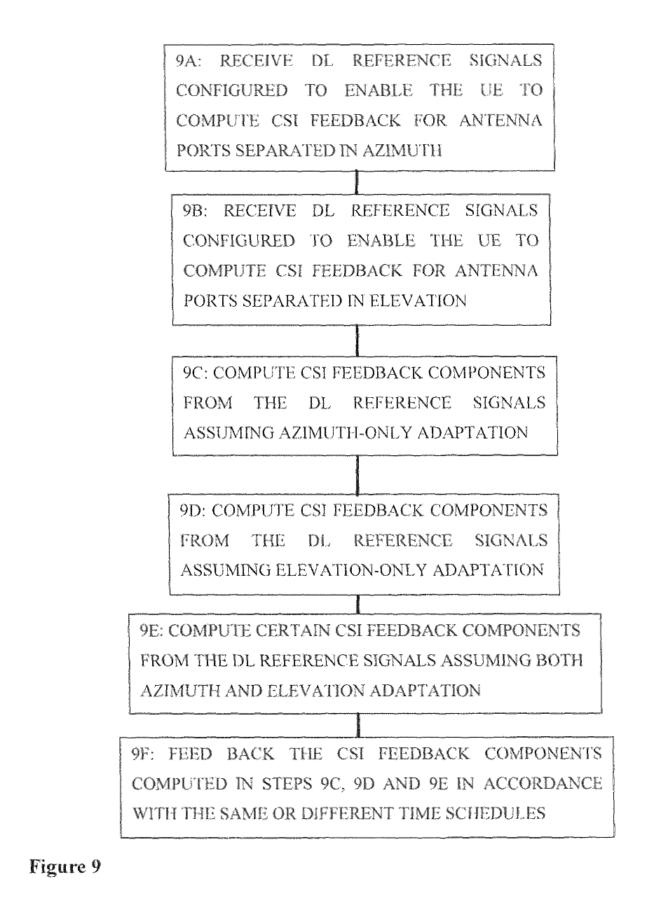

Described now with respect to FIG. 9 is one generic approach to provide feedback for 3D (three dimensional-azimuth and elevation) MIMO.

Step 9A: The UE 100 receives from the eNB 120 DL reference signals (RSs) transmitted in such a way as to enable the UE 100 to compute CSI feedback for antenna ports separated in azimuth.

Step 9B: The UE 100 receives from the eNB 120 DL reference signals (RSs) transmitted in such a way as to enable the UE 100 to compute CSI feedback for antenna ports separated in elevation.

Step 9C: The UE 100 computes certain CSI feedback components from the DL RSs assuming (UE hypothesis) azimuth-only adaptation, e.g., azimuth PMI.

Step 9D: The UE 100 computes certain CSI feedback components from the DL RSs assuming (UE hypothesis) elevation-only adaptation, e.g., elevation PMI.

Step 9E: The UE 100 computes certain CSI feedback components from the DL RSs assuming (UE hypothesis) both azimuth and elevation adaptation, e.g., CQI and RI.

Step 9F: The UE 100 feeds back to the eNB 120 CSI feedback components computed in Steps 9C, 9D and 9E in accordance with the same or different time schedules.

The UE 100 elevation-oriented information/feedback may be sent to the eNB 120 on a UE-triggered basis when the elevation-oriented feedback changes. That is, the UE 100 elevation-oriented information/feedback may be sent on an as needed basis. Alternatively the elevation-oriented feedback can be requested by the eNB 120 on an eNB-triggered basis, for example when the eNB 120 determines that the elevation-oriented feedback needs to be updated.

Note in reference to FIG. 9 that the ordering of the steps can be modified and does not imply a time sequence. Further, Steps 9A and 9B could be combined into one (optional) step. For example, the reference signals received in Steps 9A and 9B could be one set of reference signals that enable the simultaneous calculation of both elevation feedback and azimuth feedback by the UE 100.

One point to note is that the azimuth-oriented feedback message, which can be a legacy-compatible feedback message (e.g., LTE Rel-10), is decoupled from the elevation-oriented feedback message.

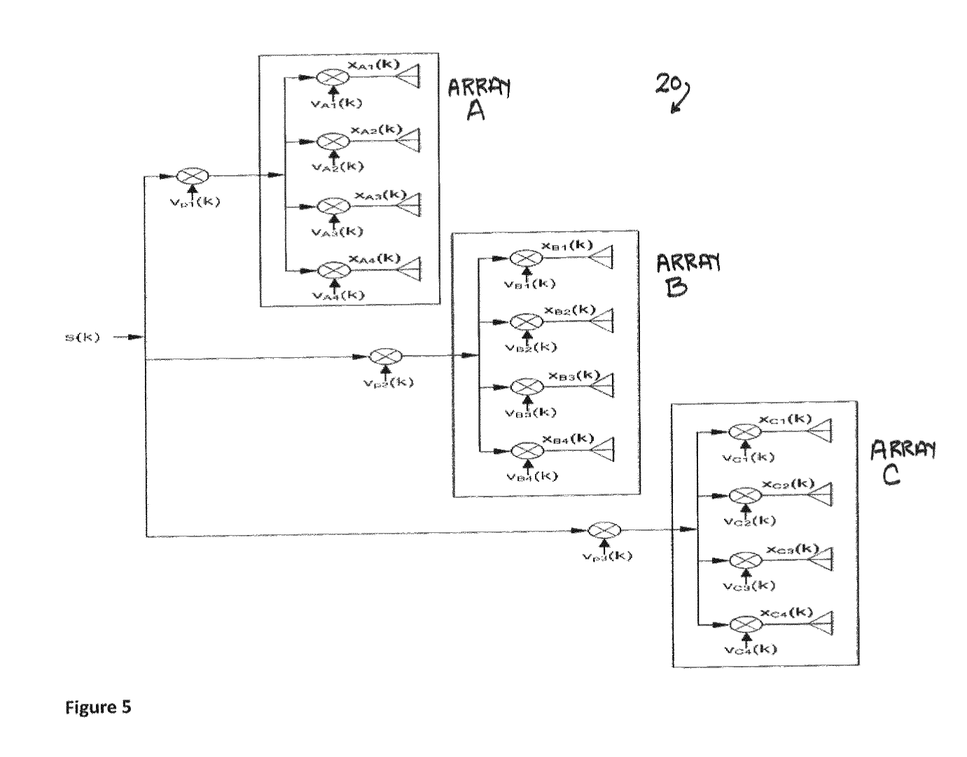

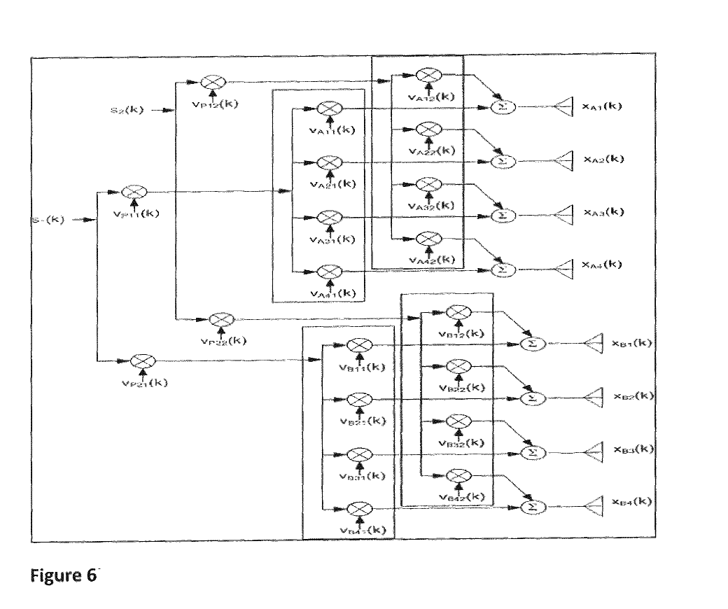

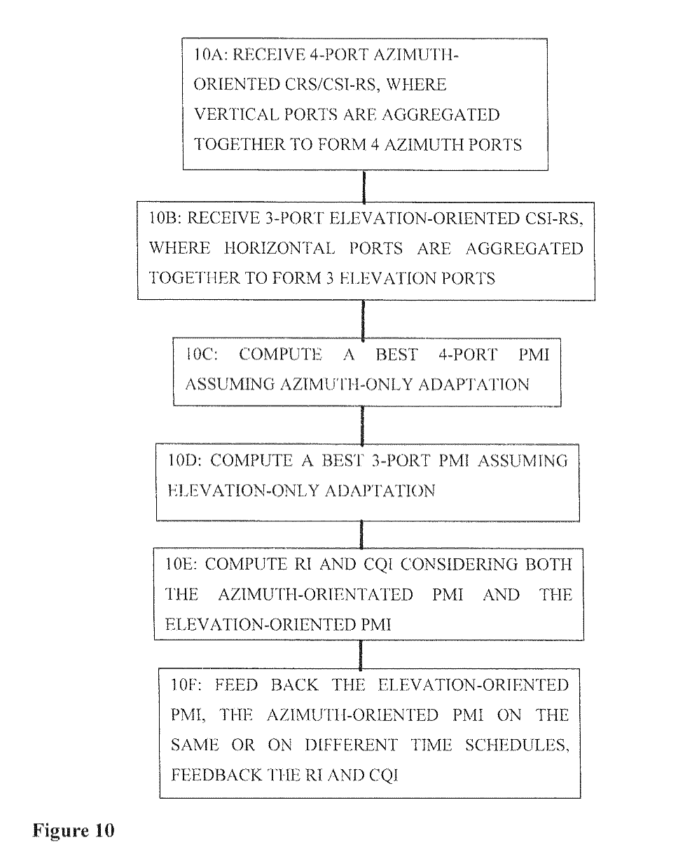

Described now with respect to FIG. 10 and FIG. 5 is another example of an approach to provide feedback for 3D MIMO, where in this non-limiting example PMI feedback is used in both elevation and azimuth. This example assumes the following conditions: M=4 azimuth×E=3 elevation; three sub-arrays—Array A, B, C; and one spatial stream in azimuth. FIG. 5, as well as FIG. 6, will be described in greater detail below.

Step 10A: The eNB 120 transmits and the UE 100 receives 4-port azimuth-oriented CRS/CSI-RS, where vertical ports are aggregated together to form 4 azimuth ports over which the 4-port CRS/CSI-RS is transmitted:

Ports {*1} are aggregated together via an aggregation strategy to form a single azimuth port with +45° polarization.

Ports {*2} are aggregated together via an aggregation strategy to form a single azimuth port with −45° polarization.

Ports {*3} are aggregated together via an aggregation strategy to form a single azimuth port with +45° polarization.

Ports {*4} are aggregated together via an aggregation strategy to form a single azimuth port with −45° polarization.

In this example, the notation {*X}, where X is a number, means the set of all antennas having the number X as the second index (e.g., {*1} refers to the set of antennas A1, B1, and C1 for this example).

The aggregation strategy can be via a specific DL phasing vector (or more generally a weight vector) that is optimized for overall cell coverage (e.g., a phasing vector that achieves a vertical pattern with a fixed 15° downtilt on each of the azimuth ports formed from the aggregation). The aggregation can be accomplished by using, for example, one of cyclic shift diversity (CSD)/cyclic delay diversity (CDD)/cyclic shift transit diversity (CSTD) or random precoding. Other methods for antenna aggregation can also be used.

Step 10B: The eNB 120 transmits and the UE 100 receives 3-port elevation-oriented CSI-RS, where horizontal ports are aggregated together to form 3 elevation ports:

Ports {A*} are aggregated together via an aggregation strategy to form a single elevation port.

Ports {B*} are aggregated together via an aggregation strategy to form a single elevation port.

Ports {C*} are aggregated together via an aggregation strategy to form a single elevation port.

In this example, the notation {Y*}, where Y is a letter, means the set of all antennas having the letter Y as the first index (e.g., {A*} refers to the set of antennas A1, A2, A3, and A4 for this example).

The aggregation strategy can be via a specific DL phasing vector that is optimized for overall cell coverage. The aggregation can be accomplished by using, for example, one of cyclic shift diversity (CSD)/cyclic delay diversity (CDD)/cyclic shift transit diversity (CSTD) or random precoding. Other methods for antenna aggregation can also be used.

Step 10C: The UE 100 sees the 4-port azimuth-oriented CRS/CSI-RS and computes a best 4-port PMI assuming azimuth-only adaptation.

Step 10D: The UE 100 sees the 3-port elevation-oriented CSI-RS and computes a best 3-port PMI assuming elevation-only adaptation.

Step 10E: The UE 100 computes the rank indication (RI) and the CQI accounting for both the azimuth-orientated PMI and the elevation-oriented PMI.

Step 10F: The UE 100 feeds back the elevation-oriented PMI, the azimuth-oriented PMI on the same or on different time schedules. For example, the feedback of the elevation-oriented PMI could be a UE-triggered process rather than a process that is scheduled or requested by the eNB 120. The UE 100 also feeds back the RI and CQI.

Note that Steps 10A and 10B represent non-limiting examples of how the DL reference signals could be transmitted and that other techniques could be used. For example, the DL reference signals may be transmitted using a straightforward M×E CRS/CSI-RS layout, and the UE 100 would be informed of the mapping from the M×E CRS/CSI-RS layout to the M×E antenna ports. The document, for example, 3GPP TS 36.211 V10.4.0 (2011-12) Technical Specification 3rd Generation Partnership Project; Technical Specification Group Radio Access Network; Evolved Universal Terrestrial Radio Access (E-UTRA); Physical Channels and Modulation (Release 10) defines the pilot layout for CRS/CSI-RS for 3GPP LTE. The document 3GPP TS 36.211 also defines the codebooks used to support closed-loop precoding. The document, for example, 3GPP TS 36.213 V10.4.0 (2011-12) Technical Specification 3^{rd} Generation Partnership Project; Technical Specification Group Radio Access Network; Evolved Universal Terrestrial Radio Access (E-UTRA); Physical layer procedures (Release 10) describes procedures by which the UE 100 and the eNB 120 report PMI, CSI, CQI, etc. For the purposes of describing this invention the various parameters and procedures described in 3GPP TS 36.211 and 3GPP TS 36.213 may be considered as ‘legacy’ parameters and procedures.

There are a number of variations that can be made to the foregoing example embodiments of this invention.

For example, the feedback for one or both of the dimensions (azimuth/elevation) can be a covariance matrix or eigenvectors, or the feedback for one or both of the dimensions (azimuth/elevation) can be PMI, or the feedback for one or both of the dimensions (azimuth/elevation) can be the actual channels (e.g., with “analog” feedback or feedback that is encoded or quantized in some manner).

Consider as an example the use of M=4 in azimuth and E=3 in elevation. In this case, and for the azimuth dimension, PMI feedback may be based on an M-antenna codebook and covariance feedback may be based on an M×M covariance matrix (e.g., quantized or analog/unquantized, etc.). Eigenvector feedback for adapting the azimuth dimension may consist of feeding back one or more M×1 eigenvectors of the M×M covariance matrix. For the elevation dimension PMI feedback may be based on an E-antenna codebook and covariance feedback may be based on an E×E elevation covariance matrix (quantized, analog, etc.). Eigenvector feedback for adapting the elevation dimension may consist of feeding back one or more E×1 eigenvectors of the E×E elevation covariance matrix.

The Steps 10A and 10B of FIG. 10 may be combined as one generic step of transmitting generic reference signals.

Also, the schedule for sending back the azimuth-oriented feedback can be the same or different from the schedule for sending back the elevation-oriented feedback. For example, the azimuth-oriented feedback may be transmitted every Nth frame while the elevation-oriented feedback may be transmitted every X*Nth frame (assuming elevation-oriented tracking can be much slower than azimuth-oriented tracking).

The elevation-oriented feedback may change at a very slow rate (as compared to the azimuth-oriented feedback) which may result in having the elevation feedback be UE-triggered when the UE 100 determines that it is necessary (rather than according to a pre-ordained schedule or an eNB-request).

Also, an additional variation on the above steps may be needed for the first time the process of jointly adapting the elevation and azimuth is performed. Ordinarily, when the UE 100 computes the best PMI, there is an inherent assumption on the best rank associated with that PMI. Furthermore, the best rank may depend on both the elevation and azimuth PMI values. Also, the final CQI value is directly related to the elevation PMI, the azimuth PMI and the Rank. As a result, the first time the process is performed, the step of computing the best PMI for azimuth adaptation (step 10C above) might involve the UE 100 computing the best azimuth PMI for each possible rank, followed by computing the best elevation PMI for each possible rank (assuming the best azimuth PMI for each rank is used). The final azimuth PMI, elevation PMI, and rank would be the combination that produces the highest data rate (or the best value of whatever metric is being used to determine best PMI/rank). Examples of metrics that can be used to determine the best PMI/rank may be functions of the data rate, signal-to-interference-plus-noise-ratio, a mutual information quantity, or a mean square error. The UE 100 may then feed back an initial set of azimuth PMI, elevation PMI, and Rank along with the associated CQI to the eNB 120 (either in one message or in separate messages). Then, as time progresses after this initialization has been performed, the process of updating one or more of the azimuth PMI, the elevation PMI, rank, and CQI could be done one or more quantities at a time assuming the other quantities were fixed at the values that were previously fed back to the eNB 120. For example, once a complete set of all four quantities (elevation PMI, azimuth PMI, Rank, CQI) has been provided (fed back) to the eNB 120, then updating the azimuth PMI and CQI would be done assuming the elevation PMI and Rank were unchanged from their values that were last fed back to the eNB 120. Similarly, updating the elevation PMI and CQI would be done assuming the azimuth PMI and Rank were unchanged from their values that were last fed back to the eNB 120. Other variations and combinations are possible and fall within the scope of this invention.

The CSI feedback content determined at the UE 100, assuming azimuth-only adaption, may include (or be the same as) legacy feedback content (for e.g. PMI/CQI/RI). This enables the eNB 120 to jointly schedule legacy UEs 100.

Feedback for one dimension may be one of frequency selective or wideband, while the feedback for the other dimension may be one of frequency selective or wideband. Joint feedback (e.g., RI, CQI) may also be one of frequency selective or wideband. In this context, “wideband” can mean the entire system bandwidth or the entire allocated signal bandwidth for the UE 100. In this context, “frequency selective” can mean feedback that is narrowband in nature, or feedback that is relevant to just a portion of the overall signal bandwidth, or feedback that contains two or more components, each relevant to a different portion of the signal bandwidth.

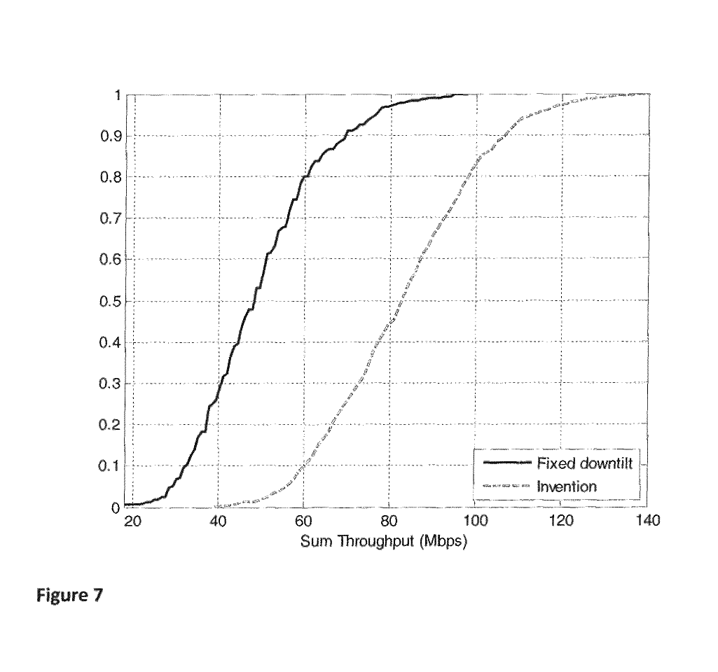

FIG. 7 is a graph that shows a result of a simulation and depicts a fixed antenna down-tilt versus a variable down-tilt made possible by the use of this invention. The simulation assumed the presence of an ITU UMa channel modified for elevation as defined in, for example, the document “D5.3: WINNER+ Final Channel Models” by Juha Meinilä, Pekka Kyösti, Lassi Hentilä, Tommi Jämsä, Essi Suikkanen, Esa Kunnari, and Milan Narand\check{z}i\acute{v}, issued Jun. 30, 2010 under the WINNER+ (Wireless World Initiative New Radio) project.

During the simulation the UE 100 locations are dropped randomly within a sector (250 m cell radius), the SNR is fixed at given level assuming a 15 degree downtilt of the eNB 120 transmit antenna 20 (no distance-based pathloss used) as measured in the main lobe of the elevation pattern. In addition, LOS and non-LOS were chosen based on a distance-based LOS probability, where the non-LOS: 26 degree azimuth angle spread, 0.363 μsec RMS delay spread, 8 degree elevation angle spread, and the LOS: 14 degree azimuth angle spread, 0.093 μsec RMS delay spread, 5 degree elevation angle spread.

During the simulation it was assumed that M=4 Tx in azimuth at the eNB 120 (XPs with 10 elements in vertical direction which gives 10 degree vertical 3 dB beamwidth when summed) and 2 Rx at the UE 100 (XP). The beamspace with E=4 four beams as compared to the fixed downtilt of 15 degrees: 10 vertical (omni) elements, 4 groups: 1-3, 4-5, 6-7, 8-10.

During the simulation the following steps were performed:

(a) the eNB 120 sounds all 4 azimuth antennas and all 4 elevation beams (CSI-RS for 16 ports);

(b) the UE 100 determines the best elevation CB from CSI-RS (averaged over the azimuth antennas);

(c) the UE 100 determines the best azimuth CB from the CSI-RS and also the elevation CB selected; and

(d) the UE 100 feeds back elevation and azimuth CBs to the eNB 120.

An LTE 4 Tx codebook was used for both azimuth and elevation, wideband feedback (20 MHz) and ideal channel knowledge was assumed (no channel estimation). A delay of 10 msec from the time of the UE 100 feedback to the time that elevation beam weights were determined was assumed for the DL transmission.

For MU-MIMO two UEs 100 were paired for the fixed downtilt (more than two UEs does not improve throughput with fixed downtilt), and six users were paired for the use of the embodiments of this invention. The resulting improvement in sum throughput (Mbps) is clearly indicated in FIG. 7, which plots the cumulative distribution function of the sum throughput (the y axis is the percentage of the time the sum throughput is less than the x axis value).

The use of the exemplary embodiments of this invention supports the joint control of both azimuth and elevation, and provides a control structure for the transmit array 20 in which the azimuth dimension is adapted separately from the elevation dimension. This control structure directly leads to a product codebook strategy in which the overall codebook is separated into two separate codebooks: one for azimuth and one for elevation. On advantage of this control structure for joint elevation/azimuth control is the opportunity to reduce the codebook search complexity, reduce the required feedback overhead, and provide flexibility for adapting the azimuth and elevation dimensions at different rates.

To control the antenna array of FIG. 4 for both azimuth and elevation a method first partitions the M×E antennas of the array into E “elevation sub-arrays”, where each sub-array consists of a row of M antenna elements. Sub-array A consists of elements A1 through A4, sub-array B consists of elements B1 through B4, and sub-array C consists of elements C1 through C4. In the following there is first described Rank 1 transmission and then transmissions having rank greater than 1.

For Rank 1 transmission, FIG. 5 shows an example for M=4, E=3 in which each elevation sub-array has an associated M=4 element sub-array weight vector: V_{A}, V_{B}, V_{C}, defined as follows:

$${V}_{A} ( k ) = [ \begin{matrix}{V}_{A 1} ( k ) \\ ⋮ \\ {V}_{AM} ( k )\end{matrix} ] , {V}_{B} ( k ) = [ \begin{matrix}{V}_{B 1} ( k ) \\ ⋮ \\ {V}_{BM} ( k )\end{matrix} ] , {V}_{C} ( k ) = [ \begin{matrix}{V}_{C 1} ( k ) \\ ⋮ \\ {V}_{CM} ( k )\end{matrix} ] , etc .$$

where the index k refers to time and/or frequency (e.g., time symbol, OFDM subcarrier, OFDMA resource block, etc.). The E=3 sub-arrays are then steered with another E=3 element weight vector, Vₚ(k), defined as follows:

$${V}_{p} ( k ) = [ \begin{matrix}{V}_{p 1} ( k ) \\ ⋮ \\ {V}_{pE} ( k )\end{matrix} ] .$$

It can be noted that thus far this notational framework for defining the transmit weights is suitable for any strategy for computing the transmit weights. In other words, any transmit weight vector of length M×E for the M×E-element antenna array can be decomposed into the above structure by simply setting Vₚ(k) to be all ones and by setting the weights in each elevation sub-array to the appropriate value.

However, for jointly controlling azimuth and elevation the embodiments of this invention may assume the use of a simplified strategy in which the E elevation sub-arrays are first beamformed in the azimuth dimension with identical weight vectors (i.e., for E=3: V_{A}=V_{B}=V_{c}) to form E identical beams in elevation. These E elevation beams are then beamformed together (i.e., “co-phased”) with the E-element weight vector Vₚ(k). To jointly adapt in both elevation and azimuth an M-antenna codebook can be used first to adapt the azimuth dimension, followed by using an E-element codebook to control the elevation dimension. Note that 3GPP Release 10 uses a two codebook strategy for the 8-antenna codebook, as described in the above-referenced 3GPP TS 36.211—EUTRA Physical Channels and Modulation.

For spatial multiplexing transmission (i.e., transmitting more than one data stream for SU-MIMO or MU-MIMO), FIG. 6 shows an extension of the Rank 1 transmission strategy of FIG. 5 to support the simultaneous transmission of more than one stream. In FIG. 6 each elevation sub-array is beamformed with an M×Ns weight matrix, where M is the number of azimuth antennas in the elevation sub-array and Ns is the number of spatial multiplexing streams (M=4, E=2, and Ns=2 in the example shown in FIG. 6). Each of the Ns streams is beamformed on each sub-array in the same manner that the single stream is beamformed on each sub-array in the Rank 1 example of FIG. 5. For each stream E beams are formed in elevation, and the E beams for each stream are then beamformed with an E-element weight vector, as is also done for each stream in the Rank 1 case of FIG. 5.

For the multiple stream case, the transmit weights are defined as follows:

$${V}_{A} ( k ) = [ \begin{matrix}{V}_{A 11} ( k ) & … & {V}_{A 1 Ns} ( k ) \\ ⋮ & & ⋮ \\ {V}_{AM 1} ( k ) & … & {V}_{AMNs} ( k )\end{matrix} ] , \\ {V}_{B} ( k ) = [ \begin{matrix}{V}_{B 11} ( k ) & … & {V}_{B 1 Ns} ( k ) \\ ⋮ & & ⋮ \\ {V}_{BM 1} ( k ) & … & {V}_{BMNs} ( k )\end{matrix} ] , \\ {V}_{C} ( k ) = [ \begin{matrix}{V}_{C 11} ( k ) & … & {V}_{C 1 Ns} ( k ) \\ ⋮ & & ⋮ \\ {V}_{CM 1} ( k ) & … & {V}_{CMNs} ( k )\end{matrix} ] and$$

$${V}_{Pi} ( k ) = [ \begin{matrix}{V}_{p 1 :} ( k ) \\ ⋮ \\ {V}_{pEi} ( k )\end{matrix} ] .$$

Given the control framework described above, the information to be fed back from the UE 100 to the eNB 120 can be divided into the following three categories.

Azimuth-oriented feedback: Information directed towards adapting in azimuth. The primary feedback information in this category is the PMI from the azimuth codebook (azimuth PMI).

Elevation-oriented feedback: Information directed towards adapting in elevation: The primary feedback information in this category is the PMI from the elevation codebook (elevation PMI).

Feedback for joint azimuth and elevation: Information directed towards the final transmission which has adapted for both elevation and azimuth. Information in this category includes the overall Channel Quality Information (CQI) and the Rank Indication (RI) and the selection of best sub-bands.

Joint or separate feedback: In one embodiment, the azimuth-oriented feedback, elevation-oriented feedback and the feedback for joint azimuth and elevation may be fed back at different time instants (this is defined as separate feedback). In this case each of the three types of feedback is separately encoded. The typical application for this embodiment is periodic feedback. The three types of feedback, however, can have different reporting periodicities. In another embodiment the three types of feedback may be fed back at the same time instant (this is defined as joint feedback). In this case two or more of the three types of feedback can be jointly encoded. All the three types of feedback can also be separately encoded. The typical application for this embodiment is aperiodic feedback. The three types of feedback have the same reporting instant. In general any two of the three types of feedback may be joint feedback.

To summarize, a non-limiting example of how this feedback framework may operate is as follows. It may be assumed that an M×E element antenna array 20 is present at the eNB 120 in which an M-antenna azimuth codebook and an E-antenna elevation codebook have been established.

Step 1: The eNB 120 transmits, and the UE 100 receives, reference signals that enable the UE 100 to compute the Azimuth-oriented PMI.

Step 2: The eNB 120 transmits, and the UE 100 receives, reference signals that enable the UE 100 to compute the Elevation-oriented PMI.

Step 3: The UE 100 computes a best Azimuth-oriented PMI, a best Elevation-oriented PMI, the Rank and the CQI

Step 4: The UE 100 feeds back the Azimuth PMI.

Step 5: The UE 100 feeds back the Elevation PMI.

Step 6: The UE 100 feeds back the Rank and the CQI.

As was noted above the ordering of these steps can be modified and do not necessarily imply a time sequence. Since the elevation aspect of the channel might change at a much slower rate than the azimuth aspect of the channel, some savings in the feedback overhead can be obtained by feeding back the Elevation PMI at slower rate than the Azimuth PMI, the CQI and/or the Rank information. The feedback for one or both of the dimensions (azimuth/elevation) can be a covariance matrix or eigenvectors rather than a PMI. The feedback for one or both of the dimensions (azimuth/elevation) can be PMI, while the feedback for one or both of the dimensions (azimuth/elevation) can be the actual channels (e.g., with “analog”/unquantized feedback or feedback that is encoded in some fashion). Steps 1 and 2 can be combined as one step of transmitting generic reference signals that allow the UE 100 to measure all M×E transmission ports. The schedule for sending back azimuth-oriented feedback can be the same or different from the schedule for sending back the elevation-oriented feedback. As the elevation-oriented feedback might change at a very slow rate the elevation feedback may be UE-triggered as opposed to using a pre-defined schedule or an eNB-request). The CSI feedback content determined at the UE 100 assuming azimuth-only adaption can include (or be the same as) legacy feedback content (e.g., for PMI/CQI/RI), thereby facilitating the task of the eNB 120 to jointly schedule legacy UEs. The feedback for one dimension may be either frequency selective or wideband in nature, while the feedback for the other dimension may be either frequency selective or wideband in nature. The joint feedback (e.g., RI, CQI) may be either frequency selective or wideband.

The various blocks shown in FIGS. 9 and 10 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Based on the foregoing it should be apparent that various exemplary embodiments provide a method, apparatus and computer program(s) that to relate to multiple input multiple output (MIMO), closed loop MIMO, downlink (DL) single user MIMO (SU-MIMO), antenna array processing, beamforming, elevation beamforming, antenna array deployment in cellular systems, codebook feedback, 3D MIMO and precoder matrix index (PMI) feedback. Various non-limiting examples include:

### Example 1

A method, comprising: receiving downlink reference signals from a transmit antenna array comprised of rows of azimuth antenna elements and columns of elevation antenna elements; computing first channel state information feedback components assuming azimuth-only adaptation; computing second channel state information feedback components assuming elevation-only adaptation; computing third channel state information feedback components assuming azimuth-adaptation and elevation adaptation; and feeding back the first, second and third channel state information feedback components.

### Example 2

The method of example 1, where feeding back the first, second and third channel state information feedback components occurs separately using the same feedback schedule.

### Example 3

The method of example 1, where feeding back at least two of the first, second and third channel state information feedback components occurs jointly.

### Example 4

The method of example 1, where feeding back the second channel state information feedback components occurs less frequently than feeding back the first channel state information feedback components.

### Example 5

The method of example 4, performed by a user equipment, where the user equipment triggers the feeding back of at least the second channel state information feedback components.

### Example 6

The method of example 1, where receiving the downlink reference signals comprises receiving first downlink reference signals and receiving second downlink reference signals both of which are configured to enable computing the third channel state information feedback components.

### Example 7

The method as in any one of examples 1-6, where the first channel state information feedback components comprise one of a codebook precoder matrix index (PMI), a covariance matrix, or eigenvectors, and where the second channel state information feedback components comprise one of a codebook precoder matrix index (PMI), a covariance matrix, or eigenvectors.

### Example 8

The method as in any one of examples 1-7, where the third channel state information is comprised of one of channel quality information (CQI) or rank indication (RI) feedback.

### Example 9

The method as in any one of examples 1-8, where the first channel state information feedback components are one of frequency selective or wideband in nature, where the second channel state information feedback components are one of frequency selective or wideband in nature, and where the third channel state information feedback components are one of frequency selective or wideband in nature.

### Example 10

The method as in example 1, where computing the first channel state information feedback components uses an azimuth codebook, and where computing the second channel state information feedback components uses an elevation-codebook.

### Example 11

The method as in any one of example 1-10, where when the method is initially performed the step of computing the first channel state information feedback components computes a best azimuth feedback component for each possible rank, the step of computing the second channel state information feedback components computes a best elevation feedback component for each possible rank, and where a final azimuth feedback component, elevation feedback component and rank is selected to be a combination that maximizes a value of a metric, and where feeding back feeds back an initial set of values of the azimuth and elevation feedback components, rank and associated channel quality indicator.

### Example 12

The method as in example 11, further comprising subsequently updating at least one of the values of the azimuth and elevation feedback components, rank and associated channel quality indicator assuming that those values that are not updated are fixed at the values of the initial set of values.

### Example 13

The method as in example 11, where the value of the metric that is maximized is a function of one of data rate, signal-to-interference-plus-noise ratio, mutual information, or mean square error.

### Example 14

A non-transitory computer-readable medium that contains software program instructions, where execution of the software program instructions by at least one data processor results in performance of operations that comprise execution of the method of any one of examples 1-13.

### Example 15

An apparatus, comprising: a processor; and a memory including computer program code, where the memory and computer program code are configured to, with the processor, cause the apparatus at least to receive downlink reference signals from a transmit antenna array comprised of rows of azimuth antenna elements and columns of elevation antenna elements; compute first channel state information feedback components assuming azimuth-only adaptation; compute second channel state information feedback components assuming elevation-only adaptation; compute third channel state information feedback components assuming azimuth-adaptation and elevation adaptation; and feed back the first, second and third channel state information feedback components.

### Example 16

The apparatus as in example 15, where the memory and computer program code are further configured with the processor to feed back the first, second and third channel state information feedback components separately using the same feedback schedule.

### Example 17

The apparatus as in example 15, where the memory and computer program code are further configured with the processor to feed back at least two of the first, second and third channel state information feedback components jointly.

### Example 18

The apparatus as in example 15, where the memory and computer program code are further configured with the processor to feed back the second channel state information feedback components less frequently than the first channel state information feedback components.

### Example 19

The apparatus as in example 18 embodied as a user equipment, and where the memory and computer program code are further configured with the processor to cause the user equipment to trigger the feedback of at least the second channel state information feedback components.

### Example 20

The apparatus as in example 15, where the memory and computer program code are further configured with the processor to receive first downlink reference signals and second downlink reference signals both of which are configured to enable computing the third channel state information feedback components.

### Example 21

The apparatus as in any one of examples 15-20, where the first channel state information feedback components comprise one of a codebook precoder matrix index (PMI), a covariance matrix, or eigenvectors, and where the second channel state information feedback components comprise one of a codebook precoder matrix index (PMI), a covariance matrix, or eigenvectors.

### Example 22

The apparatus as in any one of examples 15-21, where the third channel state information is comprised of one of channel quality information (CQI) or rank indication (RI) feedback.

### Example 23

The apparatus as in any one of examples 15-22, where the first channel state information feedback components are one of frequency selective or wideband in nature, where the second channel state information feedback components are one of frequency selective or wideband in nature, and where the third channel state information feedback components are one of frequency selective or wideband in nature.

### Example 24

The apparatus as in example 15, where the memory and computer program code are further configured with the processor to compute the first channel state information feedback components using an azimuth codebook and to compute the second channel state information feedback components using an elevation-codebook.

### Example 25

The apparatus as in any one of examples 15-24, where the memory and computer program code are further configured with the processor to initially compute a best azimuth feedback component for each possible rank, to compute a best elevation feedback component for each possible rank, and to select a final azimuth feedback component, elevation feedback component and rank to be a combination that maximizes a value of a metric, and to feed back an initial set of values of the azimuth and elevation feedback components, rank and associated channel quality indicator.

### Example 26

The apparatus as in example 25, where the memory and computer program code are further configured with the processor to subsequently update at least one of the values of the azimuth and elevation feedback components, rank and associated channel quality indicator assuming that those values that are not updated are fixed at the values of the initial set of values.

### Example 27

The apparatus as in example 25, where the value of the metric that is maximized is a function of one of data rate, signal-to-interference-plus-noise ratio, mutual information, or mean square error.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE Advanced (LTE-A) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the formulas and expressions that use these various parameters may differ from those expressly disclosed herein. Further, the various names assigned to different channels are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
BF beamforming
CQI channel quality information
RI rank information
CRS common reference signal
CSI cell-specific information
RS reference signal
LTE long term evolution
TX transmitter
RX Receiver
eNB enhanced NodeB (an LTE NodeB or base station)
BS Base Station
UE User Equipment
UMa Urban Macro
UL Uplink (UE to eNB)
DL Downlink (eNB to UE)
PMI Precoder Matrix Index
XPoI Cross Polarized
CRS Common Reference Signal
SRS sounding Reference Signal
ITU International Telecommunications Union
SNR Signal to Noise Ratio
LOS Line of Sight
NLOS Non-Line-of-Sight
FDD Frequency Division Duplex
TDD Time Division Duplex

1. A method, comprising:
receiving downlink reference signals from a transmit antenna array comprised of rows of azimuth antenna elements and columns of elevation antenna elements;
computing first channel state information feedback components assuming azimuth-only adaptation;
computing second channel state information feedback components assuming elevation-only adaptation;
computing third channel state information feedback components assuming azimuth-adaptation and elevation adaptation; and
feeding back the first, second and third channel state information feedback components.

2. The method of claim 1, where feeding back the first, second and third channel state information feedback components occurs separately using the same feedback schedule.

3. The method of claim 1, where feeding back at least two of the first, second and third channel state information feedback components occurs jointly.

4. The method of claim 1, where feeding back the second channel state information feedback components occurs less frequently than feeding back the first channel state information feedback components.

5. The method of claim 4, performed by a user equipment, where the user equipment triggers the feeding back of at least the second channel state information feedback components.

6. The method of claim 1, where receiving the downlink reference signals comprises receiving first downlink reference signals and receiving second downlink reference signals both of which are configured to enable computing the third channel state information feedback components.

7. The method as in claim 1, where the first channel state information feedback components comprise one of a codebook precoder matrix index (PMI), a covariance matrix, or eigenvectors, and where the second channel state information feedback components comprise one of a codebook precoder matrix index (PMI), a covariance matrix, or eigenvectors and where the third channel state information is comprised of one of channel quality information (CQI) or rank indication (RI) feedback.

8. (canceled)

9. (canceled)

10. (canceled)

11. The method as in claim 1, where when the method is initially performed computing the first channel state information feedback components computes a best azimuth feedback component for each possible rank, computing the second channel state information feedback components computes a best elevation feedback component for each possible rank, where a final azimuth feedback component, elevation feedback component and rank are selected to be a combination that maximizes a value of a metric, and where feeding back feeds back an initial set of values of the azimuth and elevation feedback components, rank and associated channel quality indicator.

12. The method as in claim 11, further comprising subsequently updating at least one of the values of the azimuth and elevation feedback components, rank and associated channel quality indicator assuming that those values that are not updated are fixed at the values of the initial set of values.

13. The method as in claim 11, where the value of the metric that is maximized is a function of one of data rate, signal-to-interference-plus-noise ratio, mutual information, or mean square error.

14. A computer program produce comprising a computer-readable medium bearing computer program code embodied therein for use with a computer, wherein execution of the computer program code causes the computer to perform:
receiving downlink reference signals from a transmit antenna array comprised of rows of azimuth antenna elements and columns of elevation antenna elements;
computing first channel state information feedback components assuming azimuth-only adaptation;
computing second channel state information feedback components assuming elevation-only adaptation;
computing third channel state information feedback components assuming azimuth-adaptation and elevation adaptation; and
feeding back the first, second and third channel state information feedback components.

15. (canceled)

16. An apparatus, comprising:
a processor; and
a memory including computer program code,
where the memory and computer program code are configured to, with the processor, cause the apparatus at least to perform the following:
receive downlink reference signals from a transmit antenna array comprised of rows of azimuth antenna elements and columns of elevation antenna elements;
compute first channel state information feedback components assuming azimuth-only adaptation;
compute second channel state information feedback components assuming elevation-only adaptation;
compute third channel state information feedback components assuming azimuth-adaptation and elevation adaptation; and
feed back the first, second and third channel state information feedback components.

17. The apparatus as in claim 16, where the memory and computer program code are further configured with the processor to feed back the first, second and third channel state information feedback components separately using the same feedback schedule.

18. The apparatus as in claim 16, where the memory and computer program code are further configured with the processor to feed back at least two of the first, second and third channel state information feedback components jointly.

19. The apparatus as in claim 16, where the memory and computer program code are further configured with the processor to feed back the second channel state information feedback components less frequently than the first channel state information feedback components.

20. The apparatus as in claim 19 embodied as a user equipment, and where the memory and computer program code are further configured with the processor to cause the user equipment to trigger the feedback of at least the second channel state information feedback components.

21. The apparatus as in claim 16, where the memory and computer program code are further configured with the processor to receive first downlink reference signals and second downlink reference signals both of which are configured to enable computing the third channel state information feedback components.

22. The apparatus as in claim 16, where the first channel state information feedback components comprise one of a codebook precoder matrix index (PMI), a covariance matrix, or eigenvectors, and where the second channel state information feedback components comprise one of a codebook precoder matrix index (PMI), a covariance matrix, or eigenvectors, and where the third channel state information is comprised of one of channel quality information (CQI) or rank indication (RI) feedback.

23. (canceled)

24. (canceled)

25. (canceled)

26. The apparatus as in claim 16, where the memory and computer program code are further configured with the processor to initially compute a best azimuth feedback component for each possible rank, to compute a best elevation feedback component for each possible rank, and to select a final azimuth feedback component, elevation feedback component and rank to be a combination that maximizes a value of a metric, and to feed back an initial set of values of the azimuth and elevation feedback components, rank and associated channel quality indicator.

27. The apparatus as in claim 26, where the memory and computer program code are further configured with the processor to subsequently update at least one of the values of the azimuth and elevation feedback components, rank and associated channel quality indicator assuming that those values that are not updated are fixed at the values of the initial set of values.

28. The apparatus as in claim 26, where the value of the metric that is maximized is a function of one of data rate, signal-to-interference-plus-noise ratio, mutual information, or mean square error.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)
